(19) United States
(12) Patent Application Publication
(10) Pub. No.: US 2002/0138547 A1
(43) Pub. Date: Sep. 26, 2002

(54) System and method for electronic document distribution

(76) Inventors: Darrel D. Cherry, Meridian, ID (US); Garth F. Schmeling, Boise, ID (US); Kelli H. Kennedy, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/814,302

(22) Filed: Mar. 21, 2001

(51) Int. Cl. G06F 15/16

(52) U.S. Cl. 709/201; 709/206

(57) ABSTRACT

A system and method for distributing information. The inventive system is a client-server architecture with software agents running on both the client and server systems. The invention saves time, incorporates email distribution in any application that is print capable, and allows electronic document delivery in multiple formats in addition to the native application document format. The system uses an application's print mechanism running on a client for electronic distribution of documents via email. In the illustrative embodiment, the client agent receives user interfaces from the server that allows document routing by presenting available services (such as print, email, fax, publish, etc.). The user first selects “print” from their application, such as a word processor application. The file is then intercepted by a port monitor that is launched by the printing sub-system of the network operating system. The port monitor launches an agent that transfers the file and retrieves a user interface from the server that presents the user with a list of document service selections. One of these selections is “Electronically Distribute Document.” When the user chooses this selection, the user is provided with a user interface to input destination email addresses. After the user fills out the proper destination information and selects “send”, the client agent transmits the destination information to the server agent. The server agent then attaches the printed file, which can be in different formats from the original format, postscript format (.PS), or portable document format (.PDF) depending on the user options, and emails it to the email destinations specified by the user in the destination field.

### BACKGROUND OF THE INVENTION

1. Field of the Invention

The present invention relates to computers, computing systems and networks for same. More specifically, the present invention relates to systems and methods for effecting electronic communication between computing systems via a network.

2. Description of the Related Art

As computers have become more common in the workplace and elsewhere, email has been used more widely to effect communication between computers connected via a network. While communication via email may be slower for some applications inasmuch as it generally requires use of a keyboard, it is particularly useful in the electronic communication of documents between computers. Moreover, use of email allows for a document to be distributed to a number of computers from a single source.

Currently, a separate program or ‘client’ is required to send a document from one computer to one or more receiving computers. Transmission of a document generally involves saving and closing the document in a source application, exiting the application, and opening the email client. Next, the user selects the recipients, fills in the subject line, types a message of appropriate length, selects the ‘attach file’ option and browses to find the document to be attached to the message. When the document is found, it is attached to the message and the message is sent. The sending step may involve running a separate communications program or agent.

This method is cumbersome and wasteful to time and resources on the client machine. In addition, the conventional method does not allow for a transmission of documents as attachments in a variety of formats without creating a separate document in each format to be transmitted. Further, the message may not be readable on the machines of all of the intended recipients connected to the network.

Hence, a need exists in the art for a system and method for effecting email distribution of a document that is native to the source application; simple and easy to use, universally readable and which allows for transmission in a variety of formats.

### SUMMARY OF THE INVENTION

The need in the art is addressed by the system and method for distributing information of the present invention. The inventive system is a client-server architecture with software agents running on both the client and server systems. The system uses an application's print mechanism running on a client for electronic distribution of documents via email.

In the illustrative embodiment, the client agent is a software program that communicates with the server, tranfers data to the server, and retrieves user interfaces from the server. The user first selects “print” from their application, such as a word processor application. The file is then intercepted by a port monitor that is launched by the printing sub-system of the network operating system. The port monitor launches an agent that transfers the file and retrieves a user interface from the server that presents the user with a list of document service selections. One of these selections is “Electronically Distribute Document.” When the user chooses this selection, the user is provided with a user interface to input destination email addresses. After the user fills out the proper destination information and selects “send”, the client agent transmits the destination information to the server agent. The server agent then attaches the printed file, which can be in different formats from the original format, postscript format (.PS), or portable document format (.PDF) depending on the user destination information, and emails it to the email destinations specified by the user in the destination field.

The invention saves time, incorporates email distribution in any application that is print capable, and allows electronic document delivery in multiple formats in addition to the native application document format.

### BRIEF DESCRIPTION OF THE DRAWINGS

FIG. 1 is a block diagram showing network topology consistent with the teachings of the present invention.

FIG. 2 is a block diagram of an illustrative implementation of a client computing system adapted for use in accordance with the teachings of the present invention.

FIG. 3 is a diagram showing the architecture of the client system software in accordance with the present teachings.

FIG. 4 is a block diagram of an illustrative implementation of a server system adapted for use in accordance with the teachings of the present invention.

FIG. 5 is a flow diagram illustrative of the method of operation of the client system software in accordance with the teachings of the present invention.

FIG. 6 is a flow diagram illustrative of the method of operation of the server system software in accordance with the teachings of the present invention.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Traditionally, to send a document by email, a user has to save the document in its native application, open a new “email application”, address the new email and attach the document. This method is cumbersome and wastes resources on the client system. The present invention streamlines the process and provides an email capability that is integrated into any print capable application.

FIG. 1 is a block diagram showing a network topology consistent with the teachings of the present invention. As shown in FIG. 1, the system 10 includes a number of client machines (of which five are shown for illustration) 20, 22, 24, 26 and 28 which are connected to a server 30 via a network 40. A printer 50 is shown as is typical in a local area network (LAN) configuration. Those skilled in the art will appreciate that the teachings of the present invention are not limited to LAN implementation. The present teachings may be utilized in an Internet, Intranet, wide area network (WAN), wireless or other network topology.

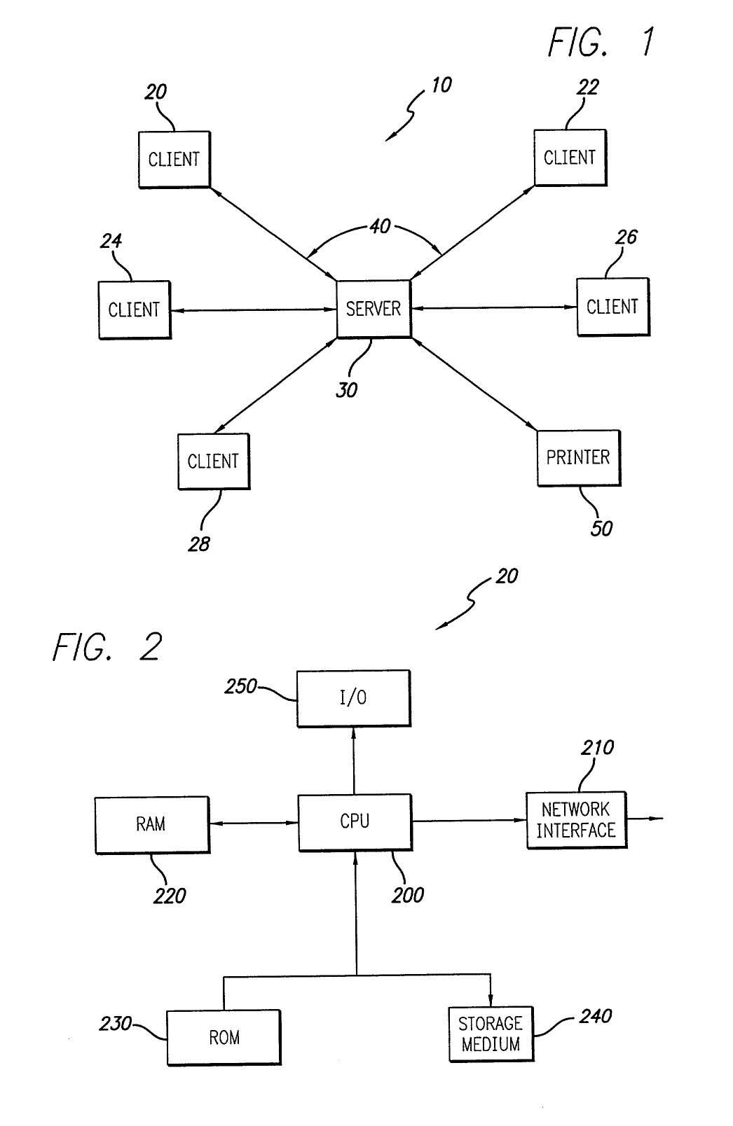

FIG. 2 is a block diagram of an illustrative implementation of a client computing system adapted for use in accordance with the teachings of the present invention. The client system 20 includes a central processing unit 200 which communicates with the network 40 via a network interface 210. The CPU 200 executes software stored in a random-access memory 220, a read-only memory 230 and a storage medium 240 and communicates with a user via an input/output interface 250 in a manner well-known to those skilled in the art.

As discussed more fully below, the client system 20 executes a variety of software applications such as word processing programs, spreadsheets, etc. (referred to herein as the “native” application) as is currently common practice. In operation, in accordance with the present teachings, on completion of a document, a user desiring to email the document to one or more recipients, first selects “print” from the native application. The file is then intercepted by a port monitor that is launched by the printing sub-system of the network operating system. The port monitor launches an agent that transfers the file and retrieves a user interface from the server that presents the user with a list of document service selections. One of these selections is the function of electronic document distribution. When the user chooses this selection, the user is provided with a user interface by the server 30 to input destination email addresses. After the user provides destination information and selects “send”, the client agent transmits the destination information to the server agent. The server agent then attaches the printed file, which can be in different formats from original format, postscript format (.PS), or portable document format (.PDF) depending on the user destination information, and emails it to the email destinations specified by the user in the destination field. Hence, two agents are employed: one agent on the client side that is launched by the port monitor and one agent on the server side that communicates with the client agent, receiving the uploaded file and serving up user interfaces in a markup language such as HTML, XML, etc. The inventive system and method is described more fully with reference to FIGS. 3-6.

FIG. 3 is a diagram showing the architecture of the client system software in accordance with the present teachings. The client side software architecture 260 includes a native application 262 which communicates with the operating system to print documents from the native application 262. As will be appreciated by those skilled in the art, the agent is a software program which may be installed on the client system or may be downloaded via the network 40 and automatically executed.

In response to user inputs, in a normal local print mode, the agent 264 passes the file to a printer (not shown) via a print driver 266, spooler 267, port monitor 268, and a printer port 272 under control of the operating system 274. In a network printing scenario, the file is passed to the network printer (50 of FIG. 1) via the port monitor 268 and network interface 270 under control of a network operating system running on the server 30. In email mode, in accordance with the present teachings, the port monitor 268 launches the agent that then communicates with the server 30 via network interface 270.

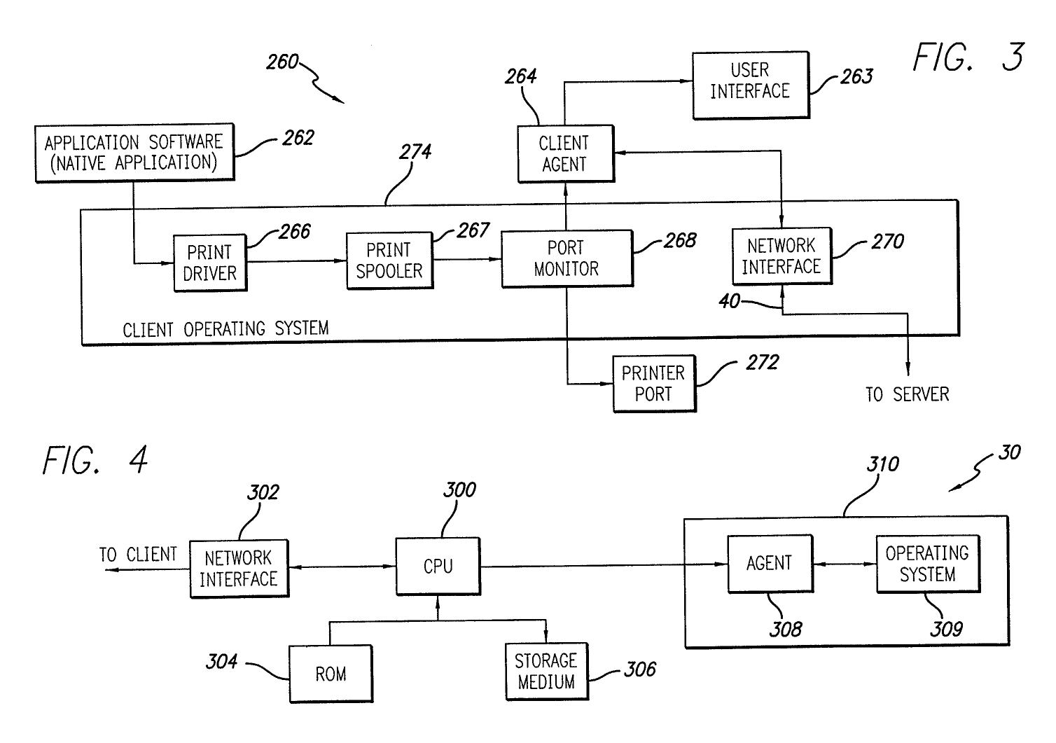

FIG. 4 is a block diagram of an illustrative implementation of a server system adapted for use in accordance with the teachings of the present invention. The server 30 includes a CPU 300, which communicates over the network 40 via a network interface 302. The server CPU 300 executes software stored in a ROM 304 and exchanges data with a storage medium 306. A random access memory 310 serves as a working memory and runs a server agent 308 and a network operating system 309.

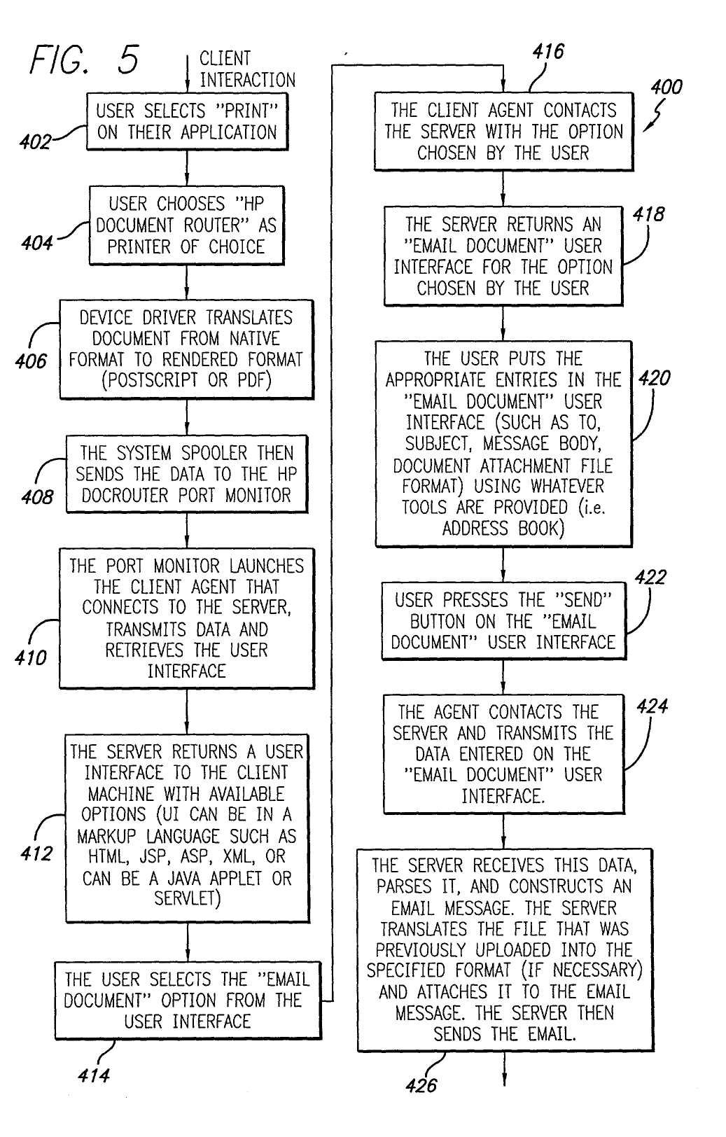

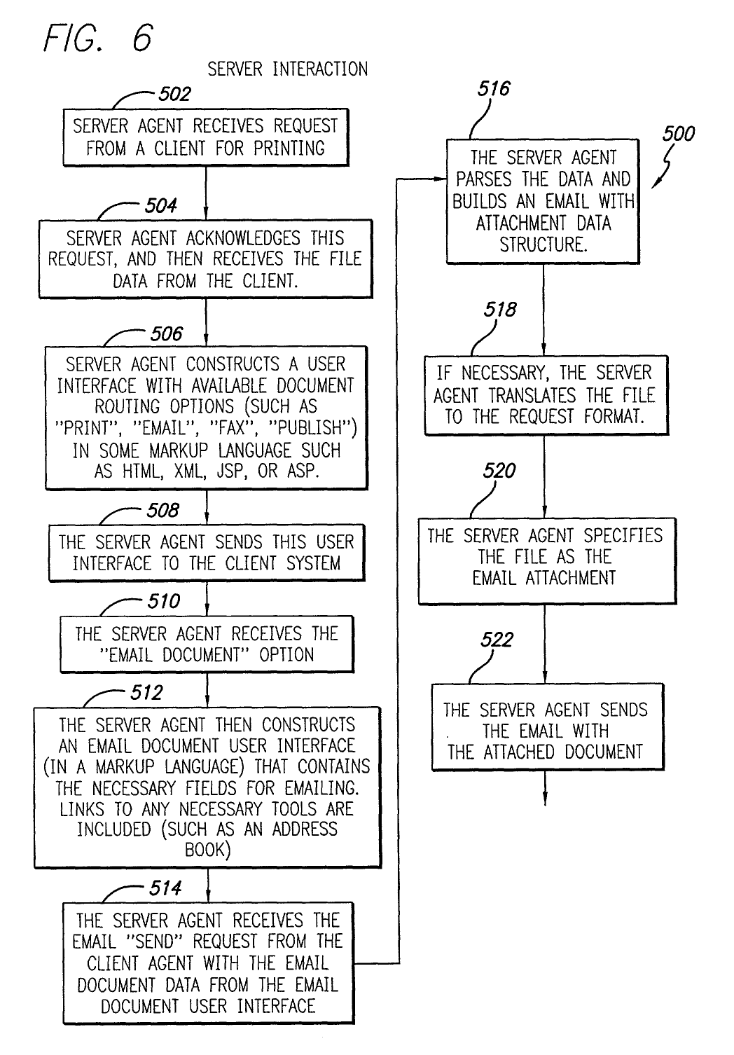

The operation of the invention is described more fully below with reference to FIGS. 5 and 6. FIG. 5 is a flow diagram illustrative of the method of operation of the system software in accordance with the teachings of the present invention. In the client methodology 400, at step 402, after completion of a document, the user selects “Print” in the native application. Next, the user chooses the document router as the printer of choice (step 404). As is known in the art, the Document Router is a logical printer installed on the client machine that uses a port monitor installed on the client machine that launches the client agent. At step 406, the print driver 266 transfers the document from its native format to a default or selected format (such as Postscript or PDF). At step 408, the system spooler sends the data to the port monitor 268 (FIG. 3). The port monitor 268 launches a client agent that connects to the server 30 and transmits the data (step 410). At step 412, the server 30 then returns a user interface (not shown) to the client agent on the client machine 20 with available options. This allows for multiple operational modes: two of which are print and email. The interface may be in a markup language such as HTML, JSP, ASP, XML, or can be a Java applet or servlet.

At step 414, the user selects the ‘email document’ option from the user interface. The user interface is launched by the client agent. The user interface could be implemented as a second agent or as a viewable part of the client agent similar to the scheme by which the Internet Explorer browser is the viewable user interface of the IEXPLORE.EXE agent. The client agent then contacts the server 30 with the option chosen by the user (step 416). At step 418, the server returns an ‘email document’ user interface for the option chosen by the user. Next, the user puts the appropriate entries in the ‘email document’ user interface such as the ‘To’, ‘Subject’, ‘Message Body’, and ‘Document Attachment file format’ fields using any provided tools such as an address book (step 420). The user then presses the send button on the ‘email document’ user interface, step 422. The agent then contacts the server and transmits the data entered in the ‘email document’ user interface (step 424).

At step 426, the server receives the data from the client, parses the data, and constructs an email message. The server translates the file that was previously uploaded into the selected format (if necessary) and attaches it to the email message. The server then sends the email to the selected destinations.

FIG. 6 is a flow diagram illustrative of the method of operation of the server system software exclusively in accordance with the teachings of the present invention. The server methodology 500 includes the first step (502) of receiving a request from a client for printing services. At step 504, the server acknowledges the request and then receives the file data from the client. The server then constructs a user interface with the available document routing options (such as ‘print’, ‘email’, ‘fax’, ‘publish’, etc.) in the appropriate markup language (step 506).

At step 508, the server sends the user interface to the client. At step 510, the server receives the ‘email document’ request. The server then constructs the ‘email document’ user interface and sends this interface to the client (step 512). The server receives an email ‘send’ request from the client agent with the email document data from the email document user interface (step 514). At step 516, the server parses the data and builds an ‘email with attachment’ data structure. If necessary, the server translates the previously uploaded file to the required format (518). The server specifies the file as an email attachment (at step 520). The server then sends the email with attached document at step 522.

Currently to select different document formats for the email attachment, a user must manually convert the document to the new format, then attach the new file to the email. Those skilled in the art will recognize that in addition to the above, the present invention, allows the user to automatically select different document formats for the email attachment. Hence, the present invention allows the user to send documents to other users in a format that they can view.

Thus, the present invention has been described herein with reference to a particular embodiment for a particular application. Those having ordinary skill in the art and access to the present teachings will recognize additional modifications applications and embodiments within the scope thereof.

It is therefore intended by the appended claims to cover any and all such applications, modifications and embodiments within the scope of the present invention.

What is claimed is:

1. A system for distributing information comprising:
a first client computer having first software with a print functionality;
a second client computer;
a network connecting said first and second client computers; and
means for effecting communication of a document from said first client to said second client as email via said print functionality thereof.

2. The invention of claim 1 wherein said first software is application software.

3. The invention of claim 1 further including a server connected to said network.

4. The invention of claim 3 wherein said means for effecting communication includes means for communicating said document through said server.

5. The invention of claim 4 wherein said means effecting communication includes a first agent running on said client.

6. The invention of claim 5 wherein means for communicating includes a second agent running on said server.

7. The invention of claim 1 further including email software running on said second client for receiving said document.

8. The invention of claim 7 wherein said email software includes means for receiving a message associated with said document from said first client.

9. A system for distributing information comprising:
a plurality of client computers, at least one client computer having application software with a print functionality;
a server;
a network connecting said client computers and said server; and
means for effecting communication of a document from said first client to said second client through said server as email via said print functionality of said application software, said means effecting communication including a first agent running on said client and a second agent running on said server.

10. The invention of claim 9 further including email software running on said second client for receiving said document.

11. The invention of claim 10 wherein said email software includes means for
receiving a message associated with said document from said first client.

12. A method for distributing information including the steps of:
providing a first client computer with first software with a print functionality;
providing a second client computer;
connecting said first and second client computers with a network; and
effecting communication of a document from said first client to said second client as email via said print functionality of said first client.
